(19) United States
(12) Patent Application Publication
(10) Pub. No.: US 2025/0116763 A1
(43) Pub. Date: Apr. 10, 2025

(54) A LIDAR APPARATUS AND PROCESS

(71) Applicant: VAI PHOTONICS PTY LTD, Australian Capital Territory (AU)

(72) Inventors: James Thomas SPOLLARD, Australian Capital Territory (AU); Lyle Edward ROBERTS, Australian Capital Territory (AU); Callum Scott SAMBRIDGE, Australian Capital Territory (AU)

(21) Appl. No.: 18/575,614

(22) PCT Filed: Jun. 30, 2022
(86) PCT No.: PCT/AU2022/050684

§ 371 Date: Dec. 29, 2023

(30) Foreign Application Priority Data
Jun. 30, 2021 (AU) 2021901996

(51) Int. Cl. G01S 7/4912; G01S 7/481; G01S 17/931; H04B 10/40

(52) U.S. Cl. CPC G01S 7/4912; G01S 7/4814; G01S 7/4816; G01S 17/931; H04B 10/40

(57) ABSTRACT

A LiDAR apparatus, including: a laser to generate an optical signal; modulation components configured to receive the optical signal as an input and to output at least two corresponding modulated optical signals at respective output ports, wherein each modulated optical signal is modulated by a corresponding pseudo-random bit sequence, and: (i) the optical signals have respective different delays such that the modulations do not overlap in time; or (ii) the pseudo-random bit sequences have low cross-correlation; for each of the at least two modulated optical signals, a corresponding optical transmitter configured to transmit the corresponding modulated optical signal towards a corresponding surface spaced from the LiDAR apparatus by a corresponding distance, and a corresponding optical receiver configured to receive a portion of the transmitted optical signal scattered and/or reflected by the surface, the received portion of the optical signal having a phase shift and/or Doppler shifted angular frequency due to radial motion of the LiDAR apparatus relative to the surface; at least one photodetector to receive the optical signals received by the optical receivers, interfered with a reference beam, and to generate a corresponding output signal; at least one analogue to digital converter to generate a digital signal representing the output signal from the at least one photodetector; and a digital signal processing component configured to process the digital signal to generate LiDAR data representing the distances to the surfaces and/or relative velocities of the surface(s) with respect to the apparatus.

### TECHNICAL FIELD

The present invention relates to LiDAR (Light Detection And Ranging) technology, and in particular to a LiDAR apparatus and process for making simultaneous measurements of distance and velocity.

### BACKGROUND

Access to reliable and accurate navigation, guidance and situational awareness data is highly sought after to ensure mission success in a wide range of applications. Industries that rely heavily on navigation technology include commercial aviation, rail transport, space systems, trucking, ride sharing, mining, urban transport providers, active target weaponry, and automotive, to name a few.

Position is a very sought-after attribute, with velocity and acceleration typically being either upstream (derived from position) or downstream (position inferred from), and determined using simple Newtonian mechanics. All metrics are quoted relative to some global reference frame, which may be a known starting position of a vehicle or other mobile asset. Knowledge of the attitude of an accelerometer can be used to transform acceleration measurements into an inertial reference frame. Position is the integral of velocity over time, with velocity being the integral of acceleration over time. Navigation is a 7 degree of freedom problem. That is, the position of any asset can be completely resolved by having access to temporal (time), translational (X, Y, and Z) and rotational (yaw, pitch, and roll) information, and coupling this information with Newtonian mechanics.

Sensors to measure these 6 spatial degrees of freedom and one temporal degree of freedom are not new, and have existed in various forms for nearly 100 years. An inertial measurement unit operates by measuring linear acceleration using one or more accelerometers, and rotational rate(s) using one or more gyroscopes. Technologies used include fiber optic gyroscopes for measuring rotations (yaw, pitch, and roll), and accelerometers for measuring translations (X, Y, and Z). Position is typically of very high importance, and any error in the measurement of rotational rate or linear acceleration will exponentially affect the position accuracy. This is because linear acceleration must be integrated twice to determine position, and rotational rate must be integrated once to determine attitude.

Any unmeasured drift in the rotation of the sensor will result in an incorrect attitude determination being reported, which when combined with linear acceleration measurement errors will result in an incorrect position being reported. As a result, it is not uncommon for a state-of-the-art Inertial Measurement Unit (IMU) to report an integrated position drift (i.e., error) of up to 100 km over the course of an hour.

To correct for this erroneous position information, an Inertial Measurement unit (IMU) can be paired with auxiliary data streams to form an Inertial Navigation System (INS). Examples include wheel speed sensors and gear selector status in vehicles to provide a dead reckoning capability, or derived position from Simultaneous Location And Mapping (SLAM) algorithms. Other sources of this second measurement of position are Global Navigation Satellite Systems (GNSS). Examples of GNSS that are commonly used include the Global Positioning System (GPS), GLObal NAvigation Satellite System (GLONASS), Galileo, and the BeiDou navigation satellite System (BDS).

There are several operational environments where GNSS signals are either unreliable or not available. In these environments, it can be difficult to obtain external measurements of the position of the sensor, often resulting in large positional drifts that have negative effects on navigation. Likewise, wheel speed sensors can produce erroneous data if traction is lost in challenging terrain, or if tracked vehicles are used.

Light Detection And Ranging (LiDAR) is a sensor technology that remotely interrogates a target of interest using a laser signal. Coherent LiDAR is capable of measuring the relative radial velocity of a target due to the Doppler effect. The Doppler shift f due to a relative velocity v relates to the carrier wavelength λ by the equation:

$$f = 2 Δ v / λ$$

The shorter the wavelength, the larger the Doppler shift. Relative velocity can thus be measured with high precision at optical wavelengths. For example, a near-infrared laser operating at a wavelength of 1064 nm will experience a 47 MHz Doppler shift at a relative velocity of 25 m/s:

$$f = 2 \times 25 ms / 1064 \times 1 {0}^{- 9} m = 47 MHz$$

As such, the absolute optical frequency of the Doppler shifted light will be:

$${f}_{L} = {f}_{0} + f$$

where f₀ is the optical carrier frequency, which is related to optical wavelength λ and the speed of light, c, by the equation:

$${f}_{0} = c / λ$$

The optical carrier frequency of a 1064 nm laser is approximately 282 THz, which is too high to measure directly using current electronics. It is thus necessary to measure changes in optical frequency using an interferometer. Interfering the Doppler shifted light with an unshifted reference (referred to as a local oscillator) at a photodetector produces an electronic signal at their difference frequency:

$${f}_{D} = {f}_{0} - {f}_{0} + f = f$$

It is possible to measure the relative rates of all rotational (yaw, pitch, and roll) and translational (X, Y, and Z) axes using a coherent LiDAR sensor if the light is aimed at the target in the correct orientation. Only the Doppler contribution of relative radial velocity can be measured, so an orientation which puts the outgoing light as close to parallel to the motion as possible is desirable. A sensor that is capable of measuring this effect has previously been disclosed in U.S. Pat. No. 9,007,569 B2, entitled “Coherent doppler lidar for measuring altitude, ground velocity, and air velocity of aircraft and spaceborne vehicles”. This patent relies on a well-known technique called Frequency Modulated Continuous Wave (FMCW) LiDAR, which relies on frequency modulation of the laser to introduce an artificial heterodyne beat-note. The range and velocity can be inferred by measuring this beat-note frequency.

Certain applications require very precise velocity measurements that have an error far less than 1 cm/s. These include, but are not limited to, vehicle position tracking for hours at a time, airborne gravimetry, and satellite docking procedures. Since FMCW relies on modulation of the laser frequency, any noise introduced from the modulation will couple into the velocity measurement and reduce the precision.

Since only relative radial velocity can be measured, the configuration and number of optical channels need to be carefully planned. For example, the motion of a train is usually constrained to forward and backward directions, and consequently a single optical channel facing along either of these directions may suffice. However, as the train moves along the railway track, it typically pitches up and down due to topography and track defects, and this movement couples into the velocity measurements. For example, in the case of a sensor that is facing backwards, a positive pitch (up) event will result in a smaller than true forward velocity measurement, whilst a negative pitch (down) event will result in a larger than true forward velocity measurement. A simple way to overcome this is to have two sensors: one facing forward, the other facing backward. Depending on the exact configuration, the effect of pitch on the velocity measurement can be removed by simply taking the average of the two measurements. However, this necessitates a second sensor.

Other situations with more degrees of freedom may necessitate more sensors, sometimes more than 10, depending on the exact performance requirements. To achieve this many channels with other technologies such as Frequency Modulated Continuous Wave LiDAR, the hardware is usually duplicated as many times as required. However, this is costly, and results in a sensor that is unnecessarily large and complex. Time division multiplexing may also be used, but this results in a reduction in the measurement bandwidth, and a consequent degradation in the quality of the data produced.

It is desired to overcome or alleviate one or more difficulties of the prior art, or to at least provide a useful alternative.

### SUMMARY

In accordance with some embodiments of the present invention, there is provided a LiDAR apparatus, including:
a laser to generate an optical signal;
modulation components configured to receive the optical signal as an input and to output at least two corresponding modulated optical signals at respective output ports, wherein each modulated optical signal is modulated by a corresponding pseudo-random bit sequence, and:
(i) the optical signals have respective different delays such that the modulations do not overlap in time; or
(ii) the pseudo-random bit sequences have low cross-correlation;
for each of the at least two modulated optical signals, a corresponding optical transmitter configured to transmit the corresponding modulated optical signal towards a corresponding surface spaced from the LiDAR apparatus by a corresponding distance, and a corresponding optical receiver configured to receive a portion of the transmitted optical signal scattered and/or reflected by the surface, the received portion of the optical signal having a phase shift and/or Doppler shifted angular frequency due to radial motion of the LiDAR apparatus relative to the surface;
at least one photodetector to receive the optical signals received by the optical receivers, interfered with a reference beam, and to generate a corresponding output signal;
at least one analogue to digital converter to generate a digital signal representing the output signal from the at least one photodetector; and a digital signal processing component configured to process the digital signal to generate LiDAR data representing the distances to the surfaces and/or relative velocities of the surface(s) with respect to the apparatus.

In some embodiments, the pseudo-random bit sequences have low cross-correlation. In some embodiments, the optical signals have respective different delays such that the modulations do not overlap in time. In some embodiments, each modulated optical signal is modulated by the same pseudo-random bit sequence.

Also described herein is a LiDAR apparatus, including:
a laser to generate an optical signal;
modulation components configured to receive the optical signal as an input and to output at least two corresponding modulated optical signals at respective output ports, wherein each modulated optical signal is modulated by a corresponding pseudo-random bit sequence, and the optical signals have respective different delays such that the modulations do not overlap in time;
for each of the at least two modulated optical signals, a corresponding optical transmitter configured to transmit the corresponding modulated optical signal towards a corresponding surface spaced from the LiDAR apparatus by a corresponding distance, and a corresponding optical receiver configured to receive a portion of the transmitted optical signal scattered and/or reflected by the surface, the received portion of the optical signal having a phase shift and/or Doppler shifted angular frequency due to radial motion of the LiDAR apparatus relative to the surface;
at least one photodetector to receive the optical signals received by the optical receivers, interfered with a reference beam, and to generate a corresponding output signal;
at least one analogue to digital converter to generate a digital signal representing the output signal from the at least one photodetector; and
a digital signal processing component configured to process the digital signal to generate LiDAR data representing the distances to the surfaces and/or relative velocities of the surface(s) with respect to the apparatus.

In some embodiments, the distances to the surface(s) are unconstrained, and the modulation components are further configured to output, from each of the output ports, and prior to outputting the modulated optical signals, a corresponding range-finding optical signal modulated by a corresponding pseudo-random bit sequence; and the digital signal processing component is further configured to, for each of the transmitted optical signals:
(i) receive range-finding signal data representing a portion of the corresponding transmitted range-finding optical signal scattered and/or reflected by the corresponding surface and received by the corresponding optical receiver;
(ii) process the range-finding signal data to generate corresponding frequency compensated signal data representing a frequency compensated signal corresponding to the received signal, but in which the Doppler shifted angular frequency has been removed and the corresponding pseudo-random bit sequence is encoded into the amplitude of the frequency compensated signal;
(iii) correlate the frequency compensated signal with a template of the corresponding pseudo-random bit sequence to generate a measurement of the distance of the corresponding surface from the LiDAR apparatus;
wherein the different delays are calculated from the distance measurements.

In some embodiments, the respective optical transmitters are arranged to transmit the respective modulated optical signals in different directions to enable navigation, telemetry, and positioning of a vehicle to which the apparatus is mounted.

In some embodiments, each optical transmitter and corresponding optical receiver constitute a corresponding optical transceiver. The optical transceivers may be, for example, beam expanders, telescopes, and/or off-axis reflectors.

In some embodiments, the different delays result from respective different optical path lengths between the output ports and the optical transmitters. In other embodiments, the different delays result from respective different electrical path lengths between a pseudo-random bit sequence generator and respective optical modulators of the modulation and delay components. In yet further embodiments, the different delays result from generating the pseudo-random bit sequence generator at different times, or from using different pseudo-random bit sequence codes for each delay.

In accordance with some embodiments of the present invention, there is provided a LiDAR process executed by a signal processing component of a LiDAR apparatus, including:
receiving digital signal data representing at least two optical signals received at respective optical receivers of the LiDAR apparatus and subsequently interfered with a reference beam, each of the at least two optical signals including a scattered and/or reflected portion of a corresponding optical signal encoded with a corresponding pseudo-random bit sequence and transmitted by a corresponding optical transmitter of the LiDAR apparatus, the scattered and/or reflected portion of the transmitted optical signal having been scattered and/or reflected from a corresponding surface spaced from the LiDAR apparatus by a corresponding distance, and having a phase shift and/or Doppler shifted angular frequency due to radial motion of the LiDAR apparatus relative to the surface, wherein the transmitted optical signals have respective different delays such that the modulations do not overlap in time; and
processing the digital signal data to generate LiDAR data representing the distances to the surface(s) and/or relative velocities of the surface(s) with respect to the LiDAR apparatus.

In some embodiments, the distances to the surface(s) are unconstrained, and the process includes calculating the different delays from respective measurements of the distances of the surface(s) from the LiDAR apparatus.

In some embodiments, each measurement of distance of the corresponding surface from the LiDAR apparatus is calculated by:
(i) receiving range-finding signal data representing a portion of a corresponding range-finding optical signal scattered and/or reflected by the corresponding surface and received by the corresponding optical receiver, the range-finding optical signal being modulated by a corresponding pseudo-random bit sequence;
(ii) processing the range-finding signal data to generate corresponding frequency compensated signal data representing a frequency compensated signal corresponding to the received signal, but in which the Doppler shifted angular frequency has been removed (if present in the signal) and the corresponding pseudo-random bit sequence is encoded into the amplitude of the frequency compensated signal;
(iii) correlating the frequency compensated signal with a template of the corresponding pseudo-random bit sequence to generate the measurement of the distance of the corresponding surface from the LiDAR apparatus.

In some embodiments, the process includes controlling respective optical modulators to modulate the optical signals with the respective different delays.

In accordance with some embodiments of the present invention, there is provided at least one computer-readable storage medium having stored thereon processor-executable instructions that, when executed by at least one processor of a LiDAR apparatus, cause the at least one processor to execute any one of the above processes.

In accordance with some embodiments of the present invention, there is provided at least one non-volatile storage medium having stored thereon FPGA configuration data that, when used to configure an FPGA, causes the FPGA to execute any one of the above processes.

In accordance with some embodiments of the present invention, there is provided at least one non-volatile storage medium having stored thereon processor-executable instructions and FPGA configuration data that, when respectively executed by at least one processor of a LiDAR apparatus and used to configure an FPGA, causes the at least one processor and FPGA to execute any one of the above processes.

### BRIEF DESCRIPTION OF THE DRAWINGS

Some embodiments of the present invention are hereinafter described, by way of example only, with reference to the accompanying drawings, wherein:

FIGS. 1 to 12 are schematic diagrams of phase-encoded LiDAR apparatuses employing Code Division Multiple Access (CDMA) in accordance with respective embodiments of the present invention, respectively using:

FIG. 1: Homodyne architecture with complex detection using a 90-degree optical hybrid dual quadrature coupler. PRBS is applied at a common phase modulator with intentional fiber delays added into each channel;

FIG. 2: Homodyne architecture with complex detection using time-separated in-phase/quadrature (I/Q) and Quadrature Phase Shift Keyed (QPSK) detection. PRBS is applied at a common phase modulator with intentional fiber delays added into each channel;

FIG. 3: Homodyne architecture with complex detection using a 120-degree multi-mode interference optical coupler. PRBS is applied at a common phase modulator with intentional fiber delays added into each channel;

FIG. 4: Homodyne architecture with complex detection using a dual quadrature coupler. PRBS is applied at a unique phase modulator for each channel, with intentional electrical cable delays from a common PRBS source for each channel;

FIG. 5: Homodyne architecture with complex detection using a dual quadrature coupler. PRBS is applied at a unique phase modulator for each channel, with a common PRBS being generated at different delays in digital signal processing for each channel;

FIG. 6: Homodyne architecture with complex detection using a dual quadrature coupler. A unique PRBS with low cross-correlation properties PRBS is applied at a unique phase modulator for each channel;

FIG. 7: Homodyne architecture with complex detection using a dual quadrature coupler. PRBS is applied at a common phase modulator with intentional fiber delays added into each channel, with four channels being shown here. Fiber couplers instead of circulators are used to separate the transmit and received signals;

FIG. 8: Heterodyne architecture with real detection using frequency shifted arm. PRBS is applied at a common phase modulator with intentional fiber delays added into each channel;

FIG. 9: Homodyne architecture with complex detection using a dual quadrature coupler. PRBS is applied at a unique phase modulator for each channel, with a common PRBS being generated at different delays in digital signal processing for each channel. A different arrangement of fiber couplers is used to separate local-oscillator and signal fields;

FIG. 10: Heterodyne architecture with real detection using frequency shifted arm. PRBS is applied at a unique phase modulator for each channel, with a common PRBS being generated at different delays in digital signal processing for each channel. Different arrange of fiber couplers to separate local-oscillator and signal fields;

FIG. 11: Homodyne architecture with real detection. PRBS is applied at a unique phase modulator for each channel, with the PRBS being generated at different delays in digital signal processing for each channel. The back reflection from the telescopes produces the reference local-oscillator, which co-propagates to the receiver using the same fiber as the signal fields;

FIG. 12: Homodyne architecture with complex detection using a dual quadrature coupler. PRBS is applied at a common phase modulator with intentional fiber delays added into each channel. A bistatic telescope arrangement is used instead of monostatic;

FIGS. 13 and 14 are schematic diagrams of LiDAR processes executed by a digital signal processor of the apparatus of FIGS. 1 to 12 to calculate time-of-flight as well as a fine frequency estimation; and

FIG. 15 is a schematic diagram of a phase encoded LiDAR apparatus with separate detection hardware for each measurement channel; and

FIGS. 16, 17, and 18 are respective graphs of the frequency components of input signals for a three channel sensor of configuration shown in FIG. 1, with decoding applied at the correct PRBS delay for Channels 1, 2, and 3, respectively;

FIG. 19 is a graph of the unwrapped phase component of a simulated three channel sensor showing the residual frequency error that is measured by a phasemeter seeded with a coarse frequency estimate; and

FIG. 20 is a block diagram of a signal processing component of the LiDAR apparatuses.

### DETAILED DESCRIPTION

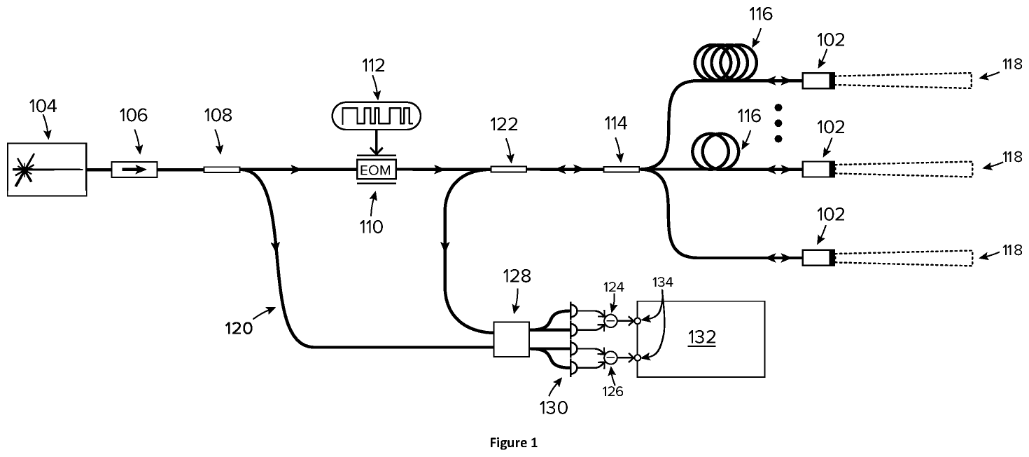

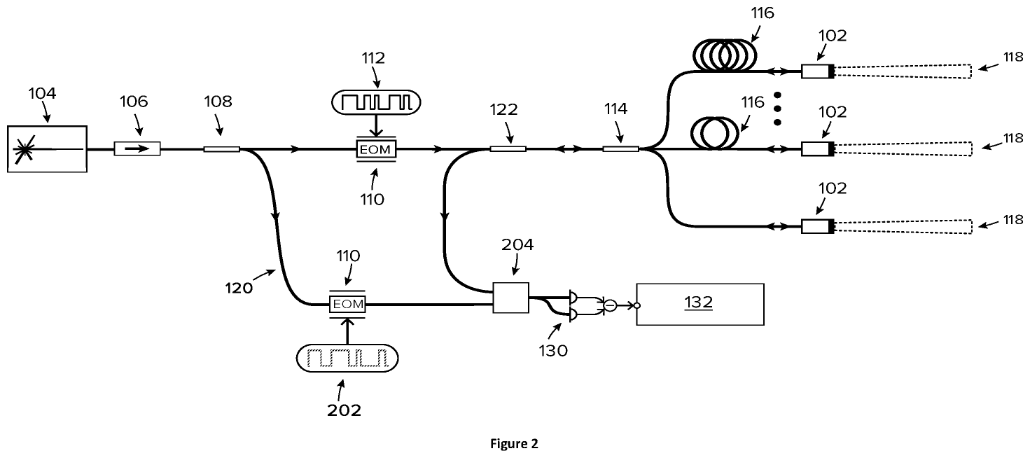

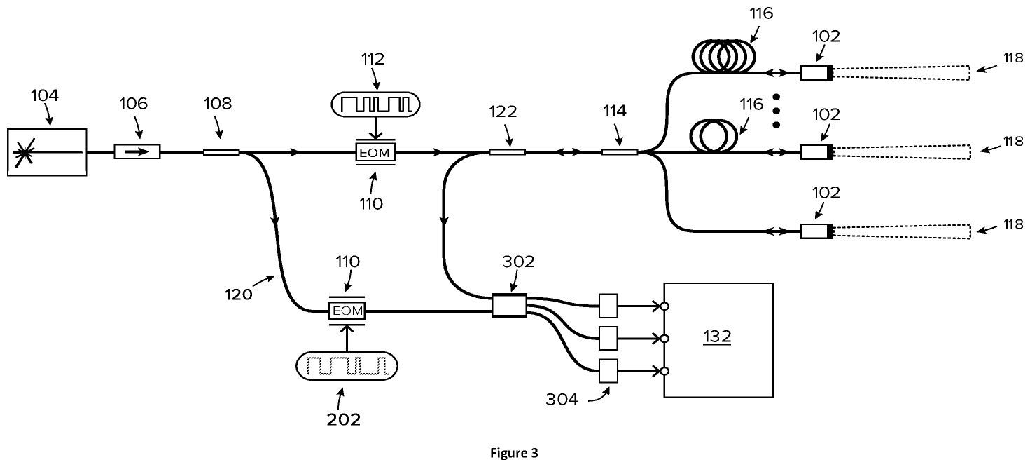

Embodiments of the present invention include LiDAR (Light Detection And Ranging) apparatuses and processes in which one or more pseudo-random bit sequences (“PRBS”) are modulated onto an optical signal generated by a laser, and split into multiple channels to simultaneously measure the distance and relative radial velocity for each channel relative to some surface(s). The channels may be, for example, directed into free space through respective telescopes, and directed at the same surface or different surfaces which scatter or reflect light back to the telescopes, each with potentially different relative radial velocities and distances. Light scattering back towards the sensor is received and then interfered at a receiver. Depending on the optical configuration, the receiver could be, for example, a 90-degree optical hybrid receiver with two balanced photodetectors as shown in FIG. 1; a 50/50 coupler with a single balanced photodetector as shown in FIG. 2; or a 3×3 ‘120-degree’ coupler with three photodetectors as shown in FIG. 3. Other configurations will be apparent to those skilled in the art in light of this disclosure.

This technology is referred to herein as “code-division multiple-access laser Doppler velocimetry” (or “CDMA LDV”) since it uses spread-spectrum code-division multiple access signal processing (similar to, for example, the Global Positioning System) to support multiplexed (i.e., more than one) measurements based on respective different delays of the sequences. The term “Laser Doppler Velocimetry” broadly describes the field of using a laser to measure velocity based on the Doppler effect, in which changes in relative radial velocity result in measurable changes in optical frequency.

A key advantage of the described invention is that it enables the separate and simultaneous measurement of multiple distinct line-of-sight velocities and distances without requiring the duplication of hardware that would otherwise be required for a single measurement channel, lowering overall hardware complexity, and instead relying on the efficient utilization of digital signal processing resources. For example, FIG. 1 shows an embodiment whose optical configuration has a single 90-degree optical hybrid and two balanced photodetectors, and which can support any practical number of individual measurement channels. This can be useful, for example, for monitoring the motion and/or vibration of a vehicle or other physical asset in multiple dimensions (e.g., vibration in x, y, and z coordinates) at the same time, without requiring duplication of signal processing hardware. CDMA LDV can also be used to measure the 3-dimensional velocity vector of a moving platform by measuring line-of-sight velocities along three respective different directions relative to some surface or surfaces, which is useful in applications requiring precise navigation. In navigation applications, CDMA LDV can provide an accurate and precise measurement of platform velocity and, by integrating the resultant 3D velocity vector, estimate of the asset's position over time as well.

Embodiments of the present invention thus enable a reduction of the overall complexity and number of hardware components by using spread-spectrum signal processing techniques which do not sacrifice measurement quality, and which provide considerable advantages when scaling the number of measurements that are required for any given application.

The LiDAR apparatuses described herein are configured for use in one of two types of application, depending on whether the distances (i.e., ranges) and radial velocities to be measured are constrained to be within a known range of values, or are unconstrained (i.e., are entirely unknown and can take any practical value).

For measurement channels that are unconstrained (i.e., when the distance between the optical output and the reflecting/scattering surface is unknown and may change appreciably over time), the relative distance between the optical output and the surface is first estimated and then used to calculate the corresponding delay of the channel. In this way, the unconstrained channel can be treated as a constrained channel. In some cases, to accurately measure distance, it is necessary to correct for disturbances in optical phase and frequency, including Doppler and other sources of phase noise. In the described embodiments, this is achieved using the process described in International Patent Application No. PCT/AU2020/051427, entitled “A LiDAR apparatus and process” (“the frequency compensation patent application”), the entirety of which is incorporated herein by reference. This process does require the duplication of receiver hardware for each measurement channel, but offers excellent measurement precision, accuracy, and dynamic range. Moreover, a key advantage of the frequency compensation described in the frequency compensation patent application is that it compensates the effects of Doppler shifting, enabling range to be calculated using a single template, and effectively collapsing a computationally intensive 2D search space into a single correlation calculation. The frequency compensation process also circumvents the need to measure and correct for a frequency shift on the received signal which, for example, could be accomplished by demodulating the input signal with a reference local oscillator prior to matched-template filtering.

### Constrained Mode

### Optical Sub-System

FIGS. 1 to 12 are schematic diagrams of respective embodiments of LiDAR apparatuses that each constitutes a Code Division Multiple Access Laser Doppler Velocimeter (CDMA LDV) using phase-encoding of a digital signal. In each embodiment, t
he optical transmitters and receivers can be oriented in the same direction or in different directions. In FIG. 1, the beam expanders (102) three can be arranged to point in different and mutually orthogonal directions, allowing the apparatus to unambiguously resolve velocity of a mobile asset in three spatial dimensions with high precision; for example, better than 1 cm/s. This high precision measurement of the asset's 3D velocity vector can be integrated a single time to estimate its position.

In FIG. 1, a laser (104) generates a coherent beam of light that is may be passed through an optical isolator (106), before being divided into two paths using a fiber coupler (108). On path acts as a local-oscillator (110). The other path is passed through an electro-optic modulator (“EOM”) (102) which is used to encode the phase of the outgoing light with a known digital signal (such as a pseudo-random bit sequence (132)). The resulting modulated light is split into multiple channels using an N port fiber coupler (126). In the embodiment of FIG. 1, the number of channels N is three, but in general any practical number (N>1) of channels may be used. In the embodiment of FIG. 1, fiber spools (104) of different lengths are used to temporally stagger the encoded signals in different channels before they are transmitted to the remote surface though beam expander (106 which are also). This outgoing/incoming light (128) is transmitted and received from the surface of the remote target. The length of each fiber channel needs to be sufficient to ensure that the returned signal lies within a respective unique subset of the of PRBS delay space.

The modulated light from each channel is transmitted via a corresponding optical transmitter to illuminate at least part of a remote surface or object that scatters and/or reflects a portion of the modulated light back towards a corresponding optical receiver of the LDV. In the described embodiments, and as shown in FIG. 1, the optical transmitter and optical receiver for each channel are one and the same, and provided in the form of a corresponding beam expander (106). (For convenience of description, that portion of light is hereinafter described as being only “scattered” from the object, but the word “scattered” is to be understood broadly and in particular to encompass both scattering and reflection in their more strict technical senses.)

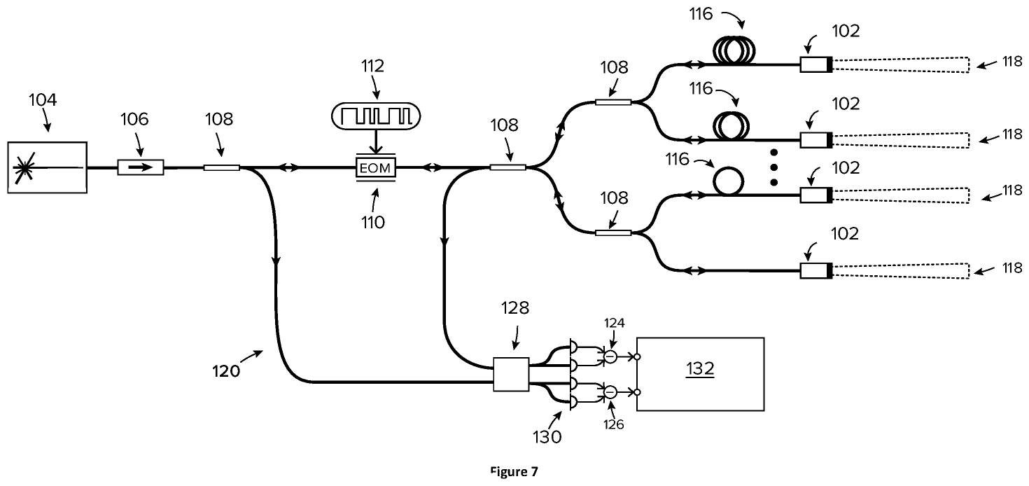

A small portion of the scattered light (an ‘echo’) is captured using the beam expander (106) and coherently interfered with a local oscillator (130). In the described embodiments, the incoming light is separated from the outgoing light (128) using a fibre optic circulator (108). In some embodiments, a fiber-optic polarization beam splitter is used in place of the fibre-optic circulator (122), or as is the case in the embodiment shown in FIG. 7 a fiber coupler is used in place of the fibre-optic circulator (122). The in-phase (I) (124) and quadrature (Q) (126) projections of the received optical signal with respect to the local oscillator are generated; for example, using a 90-degree optical coupler (128), as shown in FIG. 1. Two balanced photodetectors (116) are used to convert the electric fields produced by the 90-degree coupler (128) to voltage waveforms. The balanced photodetectors also cancel common-mode noise. The voltage signals generated by the photodetectors are discretely sampled using individual analogue-to-digital converters (ADCs) (134). The discrete-time signals generated by the ADCs are referred to collectively herein as LiDAR signal data, and are processed by the signal processing component (132) using digital signal processing. as

FIG. 2 is a schematic diagram of an alternative or ‘second’ embodiment, in which I and Q projections of the received optical signal are measured using a second electro-optic modulator in the path of the local oscillator (120) to periodically shift its phase between 0 and ±π/2 radians. Relative to the ‘first’ embodiment of FIG. 1, this embodiment transfers complexity from the optical system to digital signal (202) processing by eliminating the need for a dedicated 90-degree complex coupler (128), instead replacing it with a 180 degree fiber optic coupler (204) (e.g., in some embodiments a 3 dB coupler). In some embodiments, the periodic phase shift from 0 to ±π/2 radians is combined with the digital signal (202) modulated onto the phase of the outgoing light to produce a four-level Quadrature Phase Shift Keying (QPSK) code, eliminating the need for the second electro-optic modulator in the path of the local oscillator altogether.

FIG. 3 is a schematic diagram of a third embodiment, in which a 120-degree multimode interference coupler (302) is used to generate three projections of the received optical signal relative to the local oscillator, each rotated 120-degrees relative to each other, and thus allowing I and Q to be reconstructed in signal processing. Photodetectors are used to measure the interference of the received signal and local oscillator (120) at each of the three output ports.

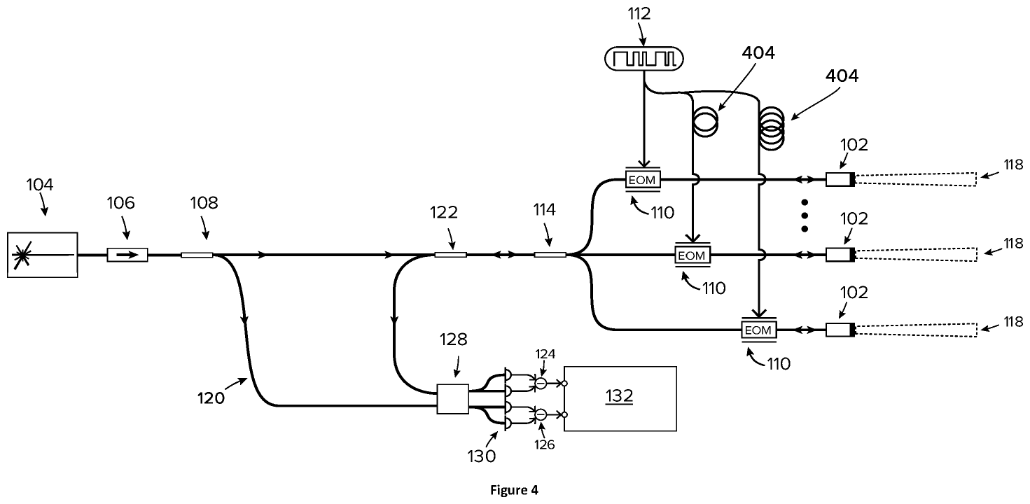

FIG. 4 is a schematic diagram of a fourth embodiment, in which each measurement channel includes its own corresponding dedicated electro-optic modulator (“EOM”) phase modulator (110). A common digital signal source is used and split into three using an electrical splitter (402). Different lengths of electrical cable are used to join the electrical splitter to the respective EOMs (110). By using varying electrical spool (404) cable lengths, the relative delay of the digital signal applied to each measurement channel can be controlled.

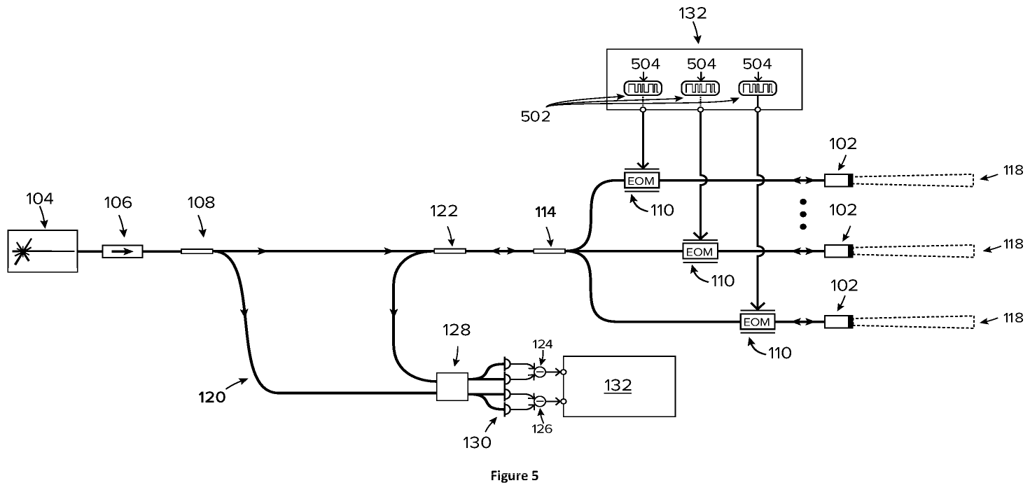

FIG. 5 is a schematic diagram of a fifth embodiment, in which each measurement channel includes a corresponding dedicated electro-optic modulator (“EOM”) (110) phase modulator. A common master digital pseudo random bit sequence (502) signal is generated by the digital signal processor, with different digital phase offset (504) delays applied by the processor to the respective channels. In each channel, a corresponding dedicated digital-to-analogue converter is used to generate an output voltage proportional to the corresponding digital signal, and which is used to drive the corresponding electro-optic modulator (“EOM”) (110) phase modulator via a corresponding electrical cable. The electrical cables may all be the same length, or they may all vary in length as described above in respect of the fourth embodiment.

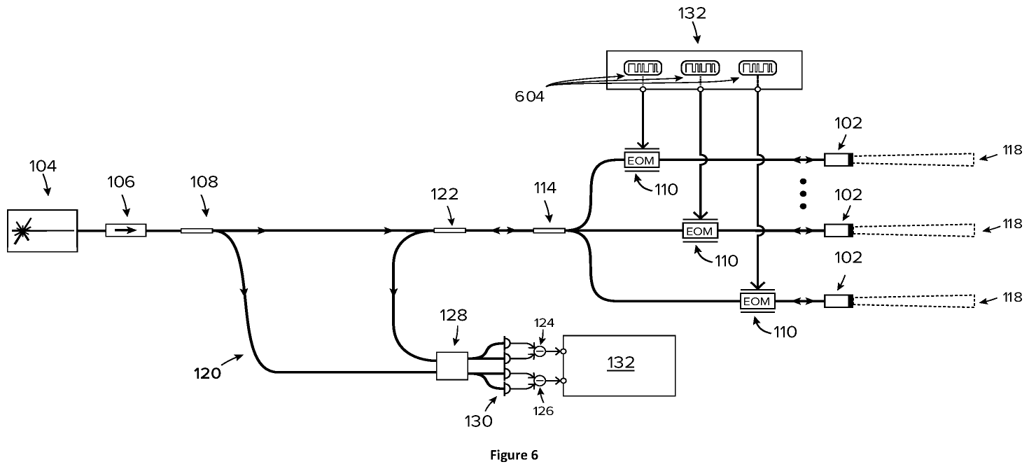

FIG. 6 is a schematic diagram of a sixth embodiment, in which each measurement channel has a corresponding dedicated electro-optic modulator (“EOM”) (110) phase modulator, and a corresponding dedicated digital-to-analogue converter (602) is used to generate an output voltage proportional to the digital signal, the output voltage being used to drive the corresponding each electro-optic modulator (“EOM”) (110) phase modulator via a corresponding electrical cable. The electrical cables may all be the same length, or they may all vary in length as described above in respect of the fourth embodiment. It is desirable that each digital signal has a different low cross-correlation bit sequence (604) properties. That is, each signal is mostly orthogonal to the others. Examples of suitable codes include maximal length sequences, and Hadamard codes. Other suitable codes will be apparent to those skilled in the art in light of this disclosure.

FIG. 7 is a schematic diagram of a seventh embodiment, wherein the incoming light is separated from the outgoing light using a fibre coupler (108). The transmitted light from the laser propagates out to a splitter network of fiber optic couplers (108) before reaching the optical beam expanders (102), whilst the received light is split back down the tree and towards the detectors. In this embodiment, t (130). he number of channels has also been increased to four. However, the number of channels is not constrained in any way, and could, for example, be 10 or more channels in other embodiments.

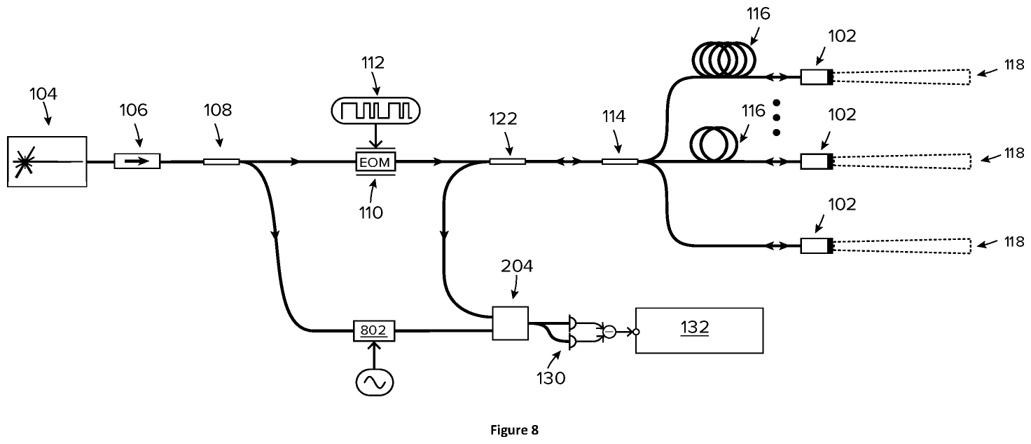

FIG. 8 is a schematic diagram of an eighth embodiment, wherein an intentional frequency shift is introduced into the local oscillator arm of the interferometer using, for example, but not restricted to, an acousto-optic modulator (AOM) (802). This forms a heterodyne interferometer, from which a complex measurement can be made by demodulating at the known frequency shift with an in-phase and quadrature component onboard the digital processor (132). This is possible because the forced frequency shift is rotating the resultant phasor of the signal at the offset frequency, thus allowing full recovery of amplitude and phase.

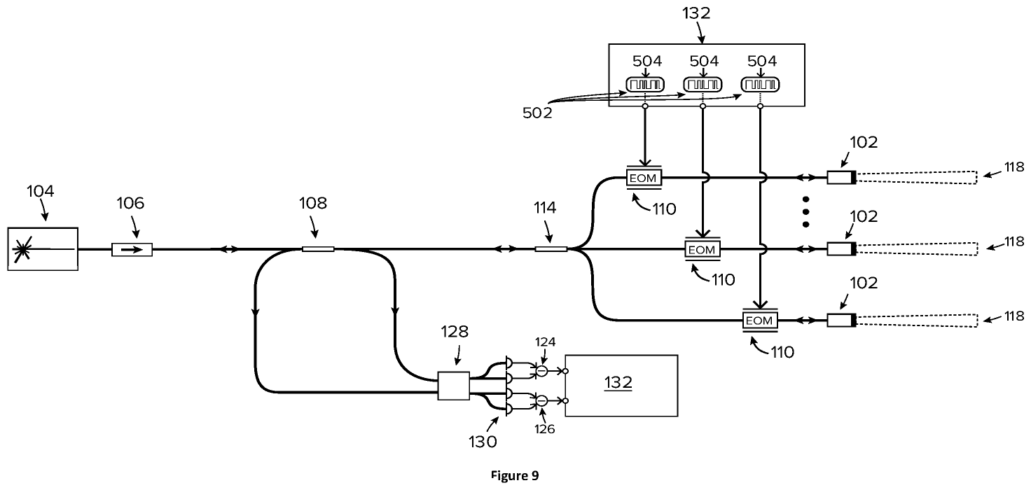

FIG. 9 is a schematic diagram of a ninth embodiment, wherein the fibre coupler (108) that is used to split the light from the laser into the local-oscillator (120) and signal beams is also used to separate the outgoing and incoming light (118). Transmitted light propagates through the coupler (108) in the forward (to the right) direction, whilst received light is propagated backwards (to the left).

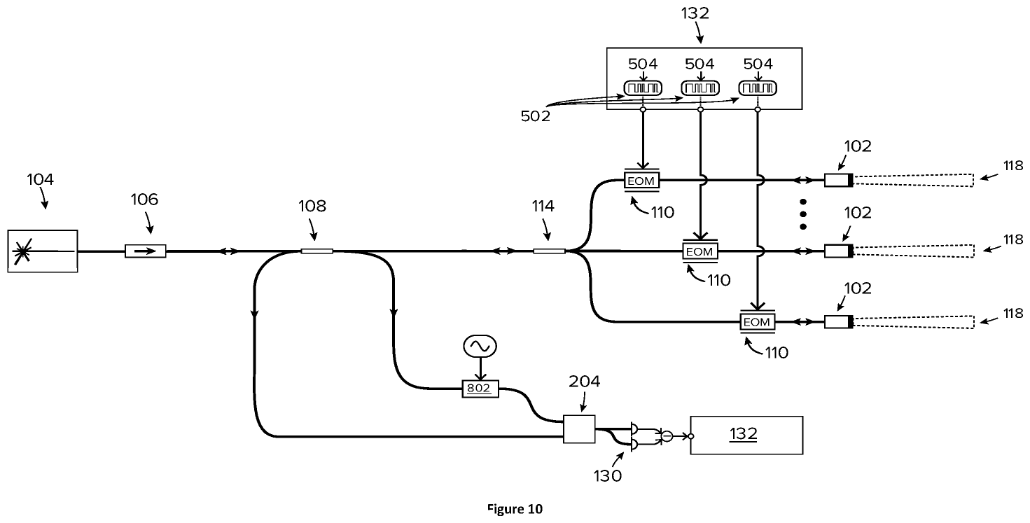

FIG. 10 is a schematic diagram of a tenth embodiment, wherein the fibre coupler (108) that is used to split the light from the laser into the local-oscillator (120) and signal beams is also used to separate the outgoing and incoming light (118). Transmitted light propagates through the coupler in the forward (to the right) direction, whilst received light is propagated backwards (to the left). A forced frequency shift has been introduced into the local oscillator arm of the interferometer using, for example, but not restricted to, an acousto-optic modulator (AOM) (802). A complex measurement can be made by demodulating at the known frequency shift with an in-phase and quadrature component onboard the digital processor (132).

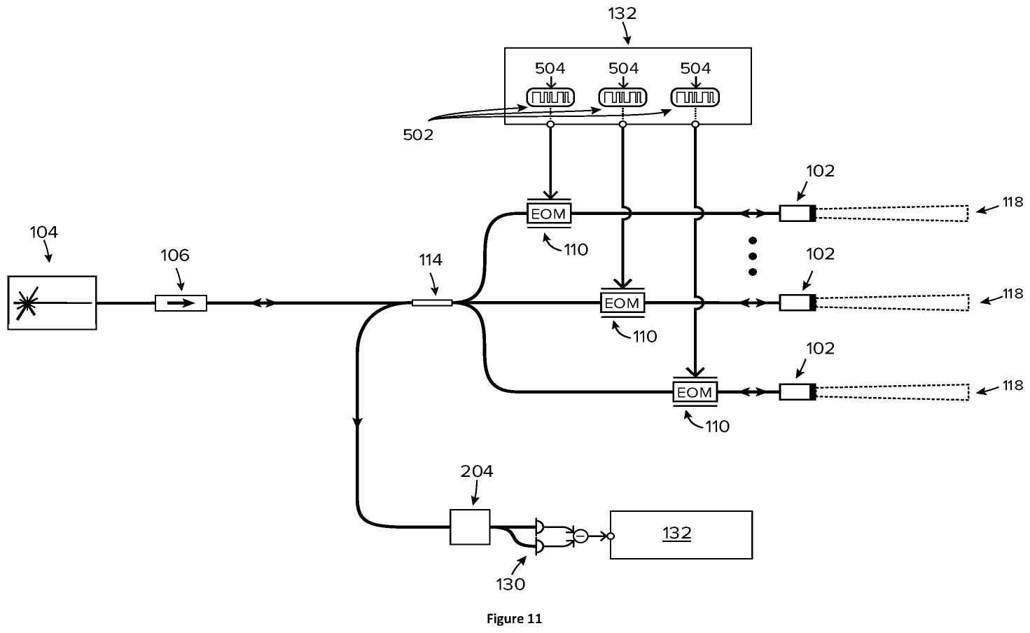

FIG. 11 is a schematic diagram of an eleventh embodiment, wherein no discrete local oscillator is provided. The light that is sent to be transmitted from the beam expanders (102) is not always entirely transmitted. Some may be lost into the cladding of the fiber, or to anti-reflective coating on various free-space optics components, such as lenses. A small amount of light is reflected back along the fiber. This can originate from, but is not restricted to, the leakage component through the circulator/fiber coupler (108) and Fresnel based back reflections from the telescope assembly from the beam expanders (102). This light can be interfered with the signal received from the remote frame of reference target to produce an interferometric signal. In this embodiment, a standard 180-degree optical coupler (204) is used to generate a differential signal for the balanced photodetectors (130). However, in some embodiments, dual quadrature detection is used. For example, a 120-degree multimode interference coupler (302) (as in the third embodiment described above), or I and Q projections of the received optical signal are measured using a second electro-optic modulator (110) in the path of the local oscillator (110) to periodically shift its phase between 0 and ±π/2 radians (as in the second embodiment).

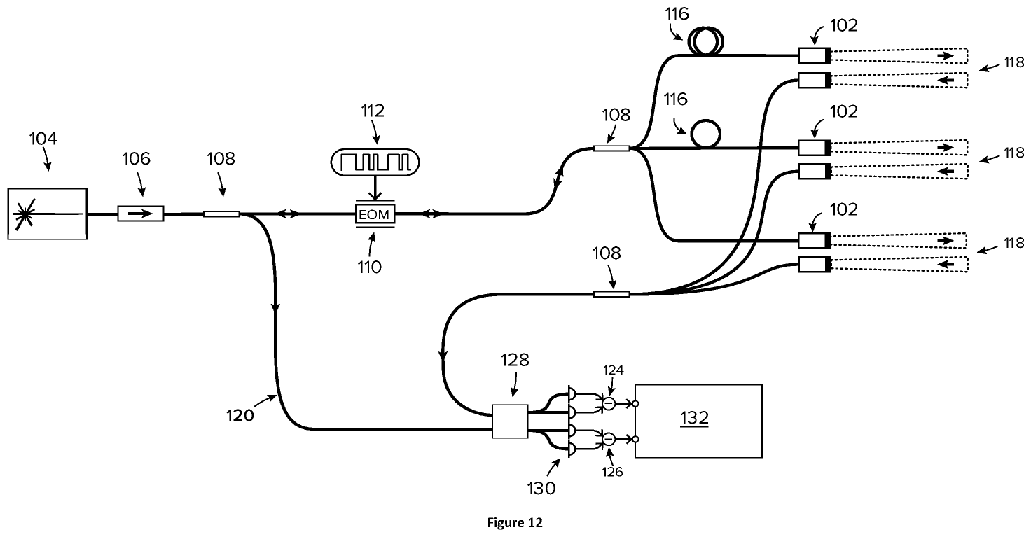

FIG. 12 is a schematic diagram of a twelfth embodiment, wherein a bistatic arrangement of optical beam expanders (102) is used for the transmit and receive optics. By using separate transmit and receive apertures, there is no opportunity for back reflected light (such as, for example, but not limited to, leakage through a circulator, or Fresnel reflections from a telescope) to propagate into the receiver. Since the spatial overlap of a bistatic arrangement is less than for a monostatic (or shared) transceiver arrangement, care should be taken to align the transmitter and receiver to maximise the overlap integral of the light.

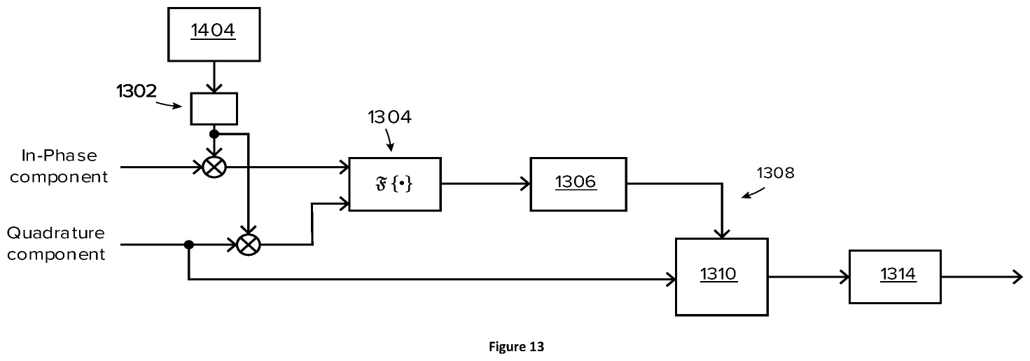

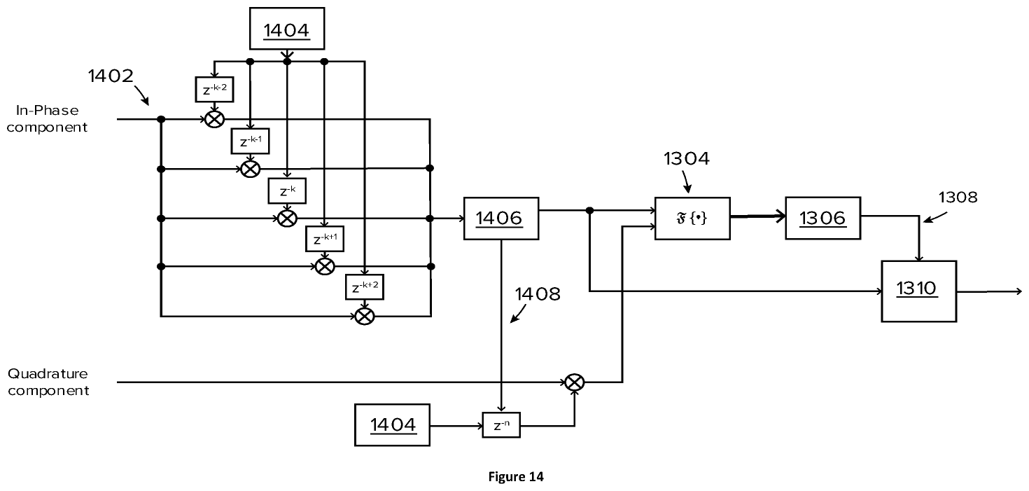

FIGS. 13 and 14 are block diagrams showing functional components of an electronics sub-system of the apparatuses of FIGS. 1 to 12. The electronic sub-system executes a LiDAR process, as also shown in FIGS. 13 and 14, that enables measurement of the relative radial velocity and range to a reference measurement plane, simultaneously for multiple measurement channels. FIG. 13 is specifically for the situation where the target range (and correct digital signal demodulation delay k (1302)) is constrained and thus already known. The input signal is first demodulated using the known digital signal at delay k, before a complex FFT is taken (1304). A peak search is performed on this output (1306), with the subsequent frequency estimate (1308) used to seed a phase locked loop (1310). The phase locked loop is then used to make a fine frequency measurement (1312) of the offset frequency by using a phase to frequency converter (1314). FIG. 14 shows the situation where the range to the target (and thus the required demodulation delay k (1402)) is known to within a few (perhaps, but not limited to, three) discrete delays of the digital signal. When the correct delay is selected, a pronounced peak of the demodulated carrier will be visible in the frequency domain when demodulated at multiple delay offsets against a template digital random sequence (1404). A signal-to-noise ratio peak search measurement (1406) is taken at each delay, with the highest value corresponding to the most likely delay. The identified peak delay is used to demodulate the in-phase component of the input signal, which is then combined with a demodulated quadrature component and fed into a complex FFT (1304). A peak search is performed on this output (1306), with the subsequent frequency estimate (1308) used to seed a phase locked loop (1310). The phase locked loop is then used to make a fine frequency measurement (1312) of the offset frequency by using a phase to frequency converter (1314). These two modes of the constrained sensor architecture still rely on the premise that the operating range of each channel will not result in an overlap with another channel.

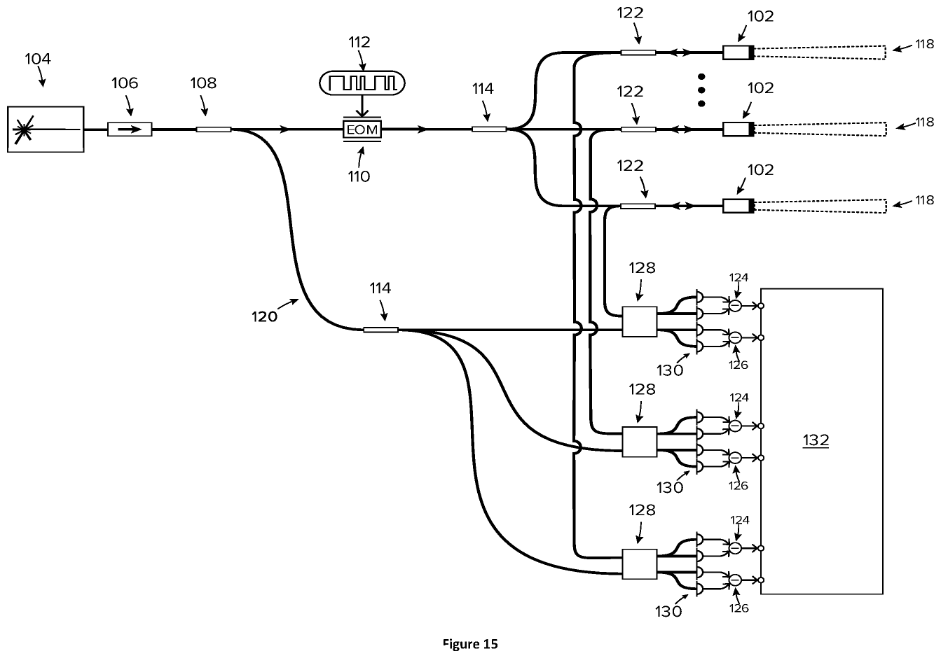

FIG. 15 is a schematic diagram of a thirteenth embodiment, where separate receiver hardware is used for each measurement channel. Notably, this includes separate circulators (122), dual quadrature receivers (128), balanced photodetectors (130) and Analogue to Digital Converters (134). This allows for the use of the process described in the frequency compensation patent application, which removes the effect of frequency offsets and phase noise on the matched template filter correlator (which is required to measure the range of the target).

Since only relative radial velocity can be measured, the configuration and number of optical channels needs to be carefully planned. In an example of a mobile asset such as a train, motion is usually constrained to forward/backwards. A single channel facing along this plane may suffice. However, as the train moves along the railway track it typically pitches up/down due to topography and track defects, and this couples into the forward velocity measurement. A positive pitch event will result in a smaller than true velocity measurement, whilst a negative pitch down event will result in a larger than true velocity measurement. A simple way to overcome this is to have two sensors: one facing forward, the other facing back. Depending on the exact configuration, the effect of pitch on the velocity measurement can be removed by simply taking the average of the two measurements. However, this necessitates a second sensor. Other situations with more degrees of freedom may necessitate more sensors, sometimes more than ten, depending on the exact performance requirements. The light exiting the laser has some amplitude A and angular frequency ω=2πf_{optical}, where f_{optical} is the optical frequency of the light. A phasor describing the electric field as a function of time can then be written as Ae^{iωt}. To address this difficulty, the inventors have developed a process whereby multiple simultaneous measurements can be made with no sacrifice in measurement quality or data throughput. This breakthrough is enabled by using Code Division Multiple Access (CDMA), which uses different digital signals to separate out each measurement channel.

The digital signal that is applied in phase to the outgoing light could, for example, in one embodiment be a Pseudo-Random Bit Sequence (PRBS) such as a maximal length sequence. An N^{th} order maximal length sequence will have a length of L=2^{N}−1. If the PRBS is modulated at rate f_{chip} which is the frequency at which one symbol/chip of the PRBS is modulated, and the resultant signal from the photodetectors is digitised using an Analog-to-Digital Converter (ADC) with a sampling frequency f_{adc}, then the oversample ratio rₒᵥₑᵣₛₐₘₚₗₑ is defined as the ratio of the ADC sample rate f_{adc} to the chip rate f_{chip} such that rₒᵥₑᵣₛₐₘₚₗₑ=f_{adc}/f_{chip}. The length of the digital sequence in terms of digital ADC samples can then be described as L_{actual}=(2^{N}−1)*rₒᵥₑᵣₛₐₘₚₗₑ.

To separate out each of the individual channels from the superposition incident signal, the delay of each signal relative to the local template must be known. Furthermore, to successfully recreate the velocity vector map relative to the reference frame (which, for example, might be the ground), there must be some knowledge of what delay belongs to what measurement channel. Say, for example, that a three-channel system is employed with respective channels for the X, Y and Z translation axes. If the sensor is moving down (negative Z), but the Z measurement channel is incorrectly interpreted as X, then the resultant velocity vector by which the corrected position is derived from will be purely forwards. This is obviously erroneous, and will result in a large position uncertainty. To overcome this, the inventors have constrained the range of possible delays for each channel to a specific subset of the overall delay space of length L_{actual}=(2^{N}−1)*rₒᵥₑᵣₛₐₘₚₗₑ. A simple implementation is to divide the overall delay space L_{actual} by the number of simultaneous measurement channels, and constrain each measurement to only occupy the subset of unique delays. For example, if the delay space has a length of 30, and 3 channels are required, then channel one can take delays 1-10, channel two delays 11-20, and channel three delays 21-30. The means by which the offset is applied to each measurement channel can take many forms, including different optical fibre lengths (as shown in FIG. 1), different electrical cable lengths (as shown in FIG. 4), or a different digital delay applied to each phase modulated signal on the digital signal processing platform (as shown in FIG. 5).

Another method to separate out the individual channels from the superposition incident signal is to apply a digital signal that has low cross-correlation properties. Examples of such signals include, but are not limited to, maximal length sequences, Walsh-Hadamard codes, Gold codes, and Kasami codes. However, these codes tend to have poorer auto-correlation properties, which further emphasises the need to know the delay of each code relative to the local template. For low cross-correlation codes, the relative delay between each channel is no longer as important. The code applied to Channel 1 will not result in a large peak when demodulating using the code applied to Channel 2. This frees up the entire delay space for use.

A pseudo-random bit sequence of type [0,1] is modulated onto the phase of the light such that the electric field becomes:

$$A {e}^{i ( ω t + β c [ n {T}_{s} ] )}$$

where μ is the modulation depth (0 to Pi), and c[nTₛ] is the discrete-time form of the pseudo-random bit sequence of type [0,1]. It is important to note that full modulation depth (i.e., when β=π) looks like an inversion of the amplitude. This is because of the sine function shift by one half period identity sin(θ+π)=−sin(θ).

The light exits each of the N channels (for example, three channels), and is reflected by the target. The complex signal that is the output from the complex coupler can be described by:

$$s [ n {T}_{s} ] = {A}_{1} {e}^{i ( ω t + β c [ ( n - {K}_{1} ) {T}_{s} ] + {θ}_{1} [ n {T}_{s} ] )} + {A}_{2} {e}^{i ( ω t + β c [ ( n - {K}_{2} ) {T}_{s} ] + {θ}_{2} [ n {T}_{s} ] )} + {A}_{3} {e}^{i ( ω t + β c [ ( n - {K}_{3} ) {T}_{s} ] + {θ}_{3} [ n {T}_{s} ] )}$$

with amplitudes Aᵢ, i=1, 2, 3, angular frequency ω=2πf, time-varying phase θᵢ[nTₛ], and c[(n−Kᵢ)Tₛ] being the known digital signal encoded in phase with modulation depth p at time delay Kᵢ. Depending on the pseudo-random bit sequence that has been modulated onto the phase of the light, demodulating at the desired delay N-K will result in suppression of the other signals.

For example, maximal length codes are a family of pseudo-random bit sequences that have length L=2^{N}−1, where N is the size of the shift-register. A 10 point shift register will generate a code that is 1023 elements long. The auto-correlation properties of any maximal length sequence are two valued:

$$R ( τ ) = \{ \begin{matrix}L & τ = kL \\ - 1 & τ \neq kL\end{matrix}$$

The received signal can then be demodulated for each channel using the prior known delay. If full modulation depth (i.e., when β=π) is used, then this looks like a digital signal amplified to the amplitude with values [1,−1]. It can be said that for full modulation depth, a [0,1] code applied in phase is converted to a [−1,1] code applied in amplitude. Taking the resultant signal applying this conversion gives:

$$s [ n {T}_{s} ] = c [ ( n - {K}_{1} ) {T}_{s} ] {A}_{1} {e}^{i ( ω t + {θ}_{1} [ n {T}_{s} ] )} + c [ ( n - {K}_{2} ) {T}_{s} ] {A}_{2} {e}^{i ( ω t + {θ}_{2} [ n {T}_{s} ] )} + c [ ( n - {K}_{3} ) {T}_{s} ] {A}_{3} {e}^{i ( ω t + {θ}_{3} [ n {T}_{s} ] )}$$

Since the code now looks like an amplitude inversion, demodulation can be applied by multiplying the received signal with the same digital signal with polarity [−1,1]. Applying the correct delay for Channel 1, this results in:

$$s [ n {T}_{s} ] = c [ ( n - {K}_{1} ) {T}_{s} ] c [ ( n - {K}_{1} ) {T}_{s} ] {A}_{1} {e}^{i ( ω t + {θ}_{1} [ n {T}_{s} ] )} + c [ ( n - {K}_{1} ) {T}_{s} ] c [ ( n - {K}_{2} ) {T}_{s} ] {A}_{2} {e}^{i ( ω t + {θ}_{2} [ n {T}_{s} ] )} + c [ ( n - {K}_{1} ) {T}_{s} ] c [ ( n - {K}_{3} ) {T}_{s} ] {A}_{3} {e}^{i ( ω t + {θ}_{3} [ n {T}_{s} ] )}$$

Since multiplying a [−1,1] code with itself undoes any modulation (−1*−1=1, 1*1=1), this simplifies to:

$$s [ n {T}_{s} ] = {A}_{1} {e}^{i ( ω t + {θ}_{1} [ n {T}_{s} ] )} + c [ ( n - {K}_{1} ) {T}_{s} ] c [ ( n - {K}_{2} ) {T}_{s} ] {A}_{2} {e}^{i ( ω t + {θ}_{2} [ n {T}_{s} ] )} + c [ ( n - {K}_{1} ) {T}_{s} ] c [ ( n - {K}_{3} ) {T}_{s} ] {A}_{3} {e}^{i ( ω t + {θ}_{3} [ n {T}_{s} ] )}$$

If the digital signal is a maximal-length sequence, then the multiplication of the digital signal with a time-delayed version of itself produces the same digital signal with a fixed sample delay, M, relative to the original digital signal. The resultant delay of the maximal-length sequence is deterministic and can simply be compensated for.

The signal for Channel 1 is now a clean sinusoid plus whatever phase noise is present in the measurement, as denoted by the phase term θ₁[nTₛ]. The other Channels are no longer sinusoids: their spectra have been spread by the digital signal. In the frequency domain, the original frequency content has been spread out (i.e., suppressed) over a much larger frequency range. It is this suppression that allows for isolation of individual measurement channels.

A coarse frequency estimation is calculated by taking a Fourier transform of the data to convert it from the time domain to the frequency domain. In an embodiment (such as the first embodiment described above) where no forced frequency offset is introduced, a complex measurement of the interfering light fields is required to disambiguate between positive (relative motion towards) or receding (relative motion away from) relative velocities. This technique resolves the direction ambiguity by measuring orthogonal projections of the received light with respect to the local oscillator, allowing the absolute relative frequency of the electronic signal to be determined by calculating a cross-spectrum or complex fast Fourier transform (FFT). The in-phase information and the quadrature information are orthogonal, and are sufficient to completely resolve the time-varying phase and frequency of the signal. In-phase and quadrature data fed to an FFT results in a single sided spectrum. The ambiguity of the direction of the frequency shift can be inferred, depending on which side of the spectrum the peak is situated. If a forced frequency oscillation is introduced (such as in the eight embodiment described above), then a complex measurement of the interfering fields is not required. This is because the relative radial velocity shift can be disambiguated by looking at the movement in the forced frequency offset. For example, if a forced offset of 80 MHz is introduced and a negative 15 MHz Doppler shift is detected, then the resultant frequency shift will be 80 MHz-15 MHz=65 MHz. Conversely, if a positive 15 MHz Doppler shift is detected, the resultant frequency shift will be 80 MHz+15 MHz=95 MHz. One such embodiment uses the Fast Fourier Transform (FFT) to exploit the computational efficiency it offers. For an input sequence of length L sampled at a rate Fs, it gives a frequency estimation with centre bin resolution of Fs/L. For example, a 1024 point FFT implemented on data that has been sampled at a rate of fₛ=52 MHz will have a bin resolution of

$$\frac{52 MHz}{1024} = 50.7 \; 81 kHz$$

Therefore, the identified peak frequency will have an error range of ±25.390 kHz.

The error of the measured frequency can be reduced by any one of several methods. One such method is to apply interpolation. This can include, but is not limited to, the quadratic method, barycentric method, Quinn's first estimator, Quinn's second estimator, or Jain's method.

Another technique to further reduce the error in the measured frequency is to use a Phase Locked Loop (PLL). Phase locked loops generate an output signal that is proportional to the phase of the input signal relative to some locally generated reference. In one embodiment, the PLL is based on a Lock-In Amplifier, which extracts the phase and amplitude of a signal from a known carrier frequency in the presence of noise. In some embodiments, this involves demodulation at the known carrier frequency (which can be aided by coarse frequency estimation), with the second harmonic of the term being filtered out using a digitally implemented low-pass filter. For example, in some embodiments the filter is a cascaded integrator comb filter that decimates the demodulated input data by an integer multiple of the code length in samples. In some embodiments, the signal is simultaneously demodulated with sine and cosine, resulting in a full dual-quadrature readout. The amplitude of the signal can be calculated by taking the sum of squares of the output, whilst the relative phase can be calculated using an arctangent function. Applying a phase unwrapping function to the discrete phase measurements allows for phase tracking to occur over multiple fringes. The relative frequency offset of the signal to the demodulation frequency can be calculated by taking the derivative of the phase data. One example of this is to simply take the difference between subsequent estimations of the phase, and to apply a scaling factor proportional to the output sampling rate of the instrument. An advantage of using a phase locked loop to track the phase and frequency of the signal is that it forms a narrow-bandwidth filter around the demodulated carrier which is always centred around the input carrier frequency because of feedback control.

### Unconstrained Mode

There are some situations where the range to the target reference surface for each measurement channel is time-varying. Such situations include, but are not limited to, spacecraft landings on interplanetary bodies, low-flying aircraft, and extremely bumpy roads. These can cause the relative delay of the modulated digital signal to change with respect to the local template. As such, the delay at which demodulation is applied may need to change to maximise the signal quality. The inventors refer to this mode of operation as “unconstrained mode”.

To identify the correct demodulation delay, a range measurement is taken to measure the round-trip time-of-flight. The Doppler shifting of the optical signal frequency poses a challenge because matched-template filtering is used to extract range information. As matched template-filtering relies on a correlation between the received signal and a local template, it is important to define the template as accurately as possible, which requires taking the Doppler shifting into account. This can be addressed by correlating the received signal with a range of different templates for respective different radial velocities. This technique works well in a post-processing or ‘offline’ context when it is acceptable to compute a series of correlations over an extended period of time. However, LiDAR for navigation requires a very high throughput of measurement data to improve the margin of safety and reduce the ability for drift to integrate.

This difficulty is overcome in the described embodiments using the process described in the frequency compensation patent application.

FIG. 15 is a schematic diagram of the thirteenth embodiment with three measurement channels and the triplication of complex measurement hardware. Whilst this embodiment features three channels, this technique is compatible with one or more measurement channels. In this embodiment, one phase modulator is used to encode all channels with the digital signal. This technique is also compatible with a separate phase modulator for each measurement channel, such as in the fifth embodiment. The constraint that the digital signal delay for each channel must not overlap is relaxed in this embodiment, since there is little to no crosstalk between channels, and there is dedicated complex measurement hardware for each channel. However, in some conditions the reference measurement surface results in some coupling of light into adjacent optical receivers. In this case, the range of possible delays for each channel can be restrained to a specific subset of delays that is unique to each measurement channel such as in the first embodiment described above.

### Signal Processing Component (Electronic Sub-System)

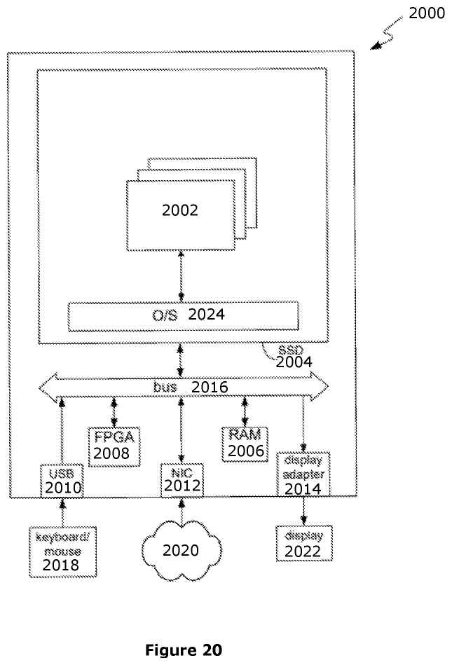

In the described embodiments, the LiDAR processes are implemented in the form of configuration data of a field-programmable gate array (FPGA) 2002 stored on a non-volatile storage medium 2004 such as a solid-state memory drive (SSD) or hard disk drive (HDD) of a signal processing component 2000 of the corresponding LiDAR apparatus, as shown in FIG. 20. However, it will be apparent to those skilled in the art that at least parts of the LiDAR processes can alternatively be implemented in other forms, for example as executable instructions of software components or modules executed by at least one microprocessor and/or by graphics processing units (GPUs), and/or as one or more dedicated hardware components, such as application-specific integrated circuits (ASICs), or any combination of these forms.

The signal processing component 2000 also includes random access memory (RAM) 2006, at least one FPGA (or processor, as the case may be) 2008, and external interfaces 2010, 2012, 2014, all interconnected by at least one bus 2016. The external interfaces may include a network interface connector (NIC) 2012 to connect the LiDAR apparatus to a communications network and may include universal serial bus (USB) interfaces 2010, at least one of which may be connected to a keyboard 2018 and a pointing device such as a mouse 2019, and a display adapter 2014, which may be connected to a display device such as a panel display 2022. The signal processing component 2000 also includes an operating system 2024 such as Linux or Microsoft Windows.

Many modifications will be apparent to those skilled in the art without departing from the scope of the present invention.

### Example

The three-channel phase-encoded code division multiple access laser doppler velocimeter shown in FIG. 1 was simulated. A single digital signal in the form of a 10-bit maximal length sequence with a digitised oversample ratio of two was applied to one common EOM phase modulator with full Pi modulation depth, before being split into each measurement signal. Delays were introduced such that channel one was in the delay range 1-20, channel two in the delay range 21-40, and channel three in the delay range 41-60. The specific delays of the target signals for each of the three channels was 13, 33, and 53, respectively. A frequency offset in the form of a constant Doppler shift was simulated for each target. Channel one had a Doppler shift of 6.0484 MHz, channel two had a Doppler shift of −23.827 MHz, and channel three had a Doppler shift of −9.1642 MHz. A prompt reflection originating from the optical transmitting was also simulated with equal power to that of the target. A digital sampling frequency of 125 MHz was used with an observation period of 2046 samples.

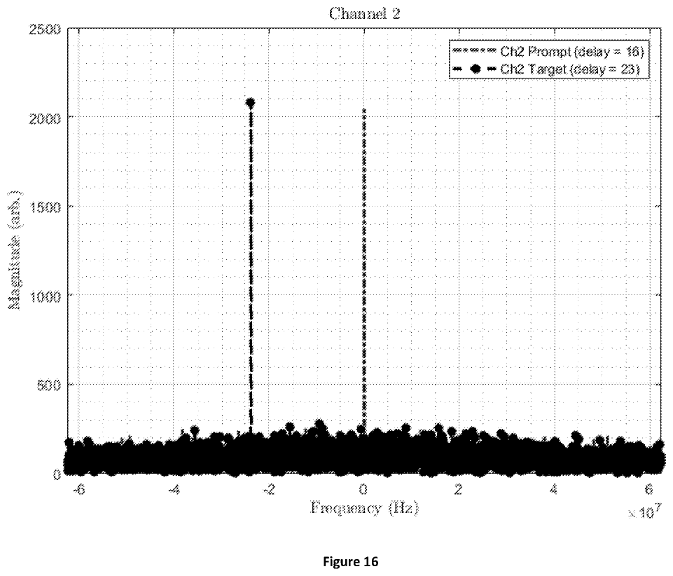

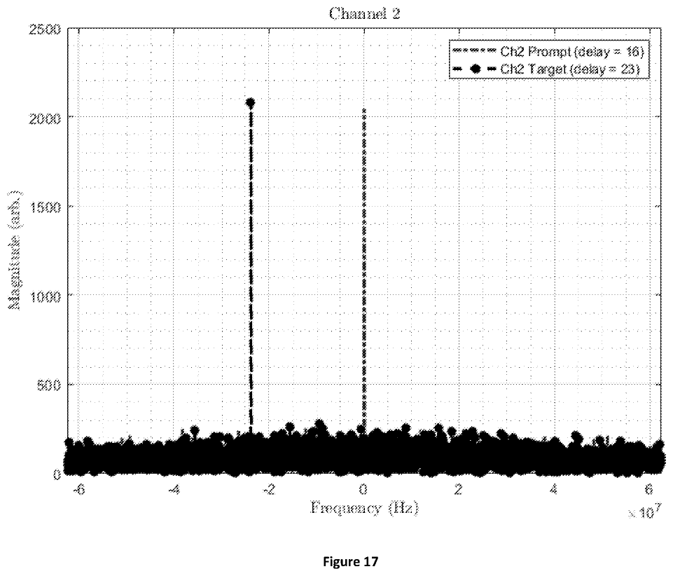

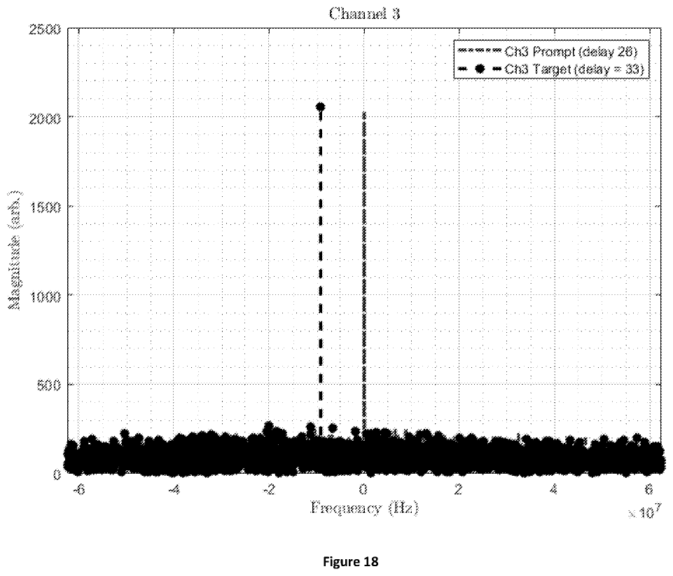

The digital signal processing (LiDAR process) of FIG. 13 was applied to the signals. The In-Phase and Quadrature signals were demodulated using the corresponding digital signal delay for each channel at both the target delay and the prompt signal delay. A Fourier Transform was performed on the demodulated data for channels 1, 2, and 3, as shown in FIGS. 16, 17, and 18, respectively.

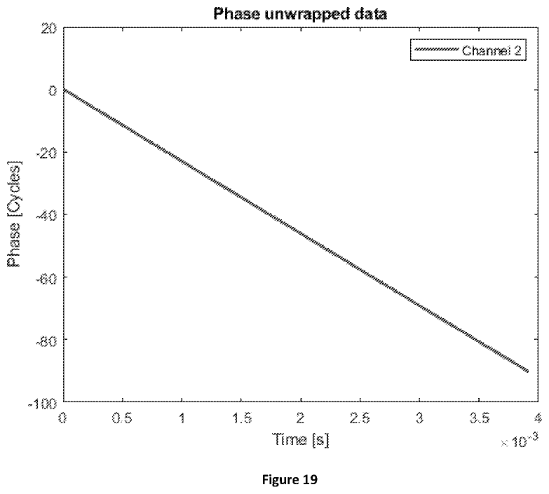

A peak search was performed on the frequency domain data with the identified peak frequency used as the demodulation frequency in a lock-in amplifier. For example, the peak frequency for Channel two was identified as −23.888074 MHz, compared to the true frequency of Channel 2 of −23.865 MHz. This is a difference of 23.1 kHz. The lock-in amplifier was constructed from a second order cascaded-integrator comb filter, with a filter length of 490 samples. The unwrapped phase output of this measurement is shown in FIG. 19. The phase of the Channel two signal evolved by −90.2391 cycles over a period of 3.916 milliseconds. A conversion to frequency was achieved by integrating this over 1 second, producing an offset of −23.043 kHz. The final frequency was calculated by taking the coarse frequency estimate, and subtracting the fine frequency correction for the lock-in amplifier. For this example, it is −23.888074 MHz-−23.043 kHz=−23.865031 MHz. This is only 31 Hz from the actual frequency of 23.865 MHz.

1. A LiDAR apparatus, including:
a laser configured to generate an optical signal;
modulation components configured to receive the optical signal as an input and to output at least two corresponding modulated optical signals at respective output ports, wherein each modulated optical signal is modulated by a corresponding pseudo-random bit sequence, and:
(i) the optical signals have respective different delays such that the modulations do not overlap in time; or
(ii) the pseudo-random bit sequences have low cross-correlation;
for each of the at least two modulated optical signals, a corresponding optical transmitter configured to transmit the corresponding modulated optical signal towards a corresponding surface spaced from the LiDAR apparatus by a corresponding distance, and a corresponding optical receiver configured to receive a portion of the transmitted optical signal scattered and/or reflected by the surface, the received portion of the optical signal having a phase shift and/or Doppler shifted angular frequency due to radial motion of the LiDAR apparatus relative to the surface;
at least one photodetector configured to receive the optical signals received by the optical receivers, interfered with a reference beam, and to generate a corresponding output signal;
at least one analogue to digital converter configured to generate a digital signal representing the output signal from the at least one photodetector; and
a digital signal processing component configured to process the digital signal to generate LiDAR data representing the distances to the surfaces and/or relative velocities of the surface(s) with respect to the apparatus.

2. The apparatus of claim 1, wherein the respective optical transmitters are arranged to transmit the respective modulated optical signals in different directions to enable navigation, telemetry, and positioning of a vehicle to which the apparatus is mounted.

3. The apparatus of claim 1, wherein each optical transmitter and corresponding optical receiver constitute a corresponding optical transceiver.

4. The apparatus of claim 3, wherein the optical transceivers are beam expanders, telescopes, and/or off-axis reflectors.

5. The apparatus of claim 1, wherein the pseudo-random bit sequences have low cross-correlation.

6. The apparatus of claim 1, wherein the optical signals have respective different delays such that the modulations do not overlap in time.

7. The apparatus of claim 6, wherein each modulated optical signal is modulated by the same pseudo-random bit sequence.

8. The apparatus of claim 6, wherein the distances to the surface(s) are unconstrained, and the modulation components are further configured to output, from each of the output ports, and prior to outputting the modulated optical signals, a corresponding range-finding optical signal modulated by a corresponding pseudo-random bit sequence; and the digital signal processing component is further configured to, for each of the transmitted optical signals:
(i) receive range-finding signal data representing a portion of the corresponding transmitted range-finding optical signal scattered and/or reflected by the corresponding surface and received by the corresponding optical receiver;
(ii) process the range-finding signal data to generate corresponding frequency compensated signal data representing a frequency compensated signal corresponding to the received signal, but in which the Doppler shifted angular frequency has been removed and the corresponding pseudo-random bit sequence is encoded into an amplitude of the frequency compensated signal; and
(iii) correlate the frequency compensated signal with a template of the corresponding pseudo-random bit sequence to generate a measurement of the distance of the corresponding surface from the LiDAR apparatus;
wherein the different delays are calculated from the distance measurements.

9. The apparatus of claim 6, wherein the different delays result from respective different optical path lengths between the output ports and the optical transmitters.

10. The apparatus of claim 6, wherein the different delays result from respective different electrical path lengths between a pseudo-random bit sequence generator and respective optical modulators of the modulation and delay components.

11. The apparatus of claim 6, wherein the different delays result from generating the pseudo-random bit sequence generator at different times.

12. The apparatus of claim 6, wherein the different delays result from using different pseudo-random bit sequence codes for each delay.

13. A method executed by a signal processing component of a LiDAR apparatus, the method including:
receiving digital signal data representing at least two optical signals received at respective optical receivers of the LiDAR apparatus and subsequently interfered with a reference beam, each of the at least two optical signals including a scattered and/or reflected portion of a corresponding optical signal encoded with a corresponding pseudo-random bit sequence and transmitted by a corresponding optical transmitter of the LiDAR apparatus, the scattered and/or reflected portion of the transmitted optical signal having been scattered and/or reflected from a corresponding surface spaced from the LiDAR apparatus by a corresponding distance, and having a phase shift and/or Doppler shifted angular frequency due to radial motion of the LiDAR apparatus relative to the surface, wherein the transmitted optical signals have respective different delays such that modulations do not overlap in time; and
processing the digital signal data to generate LiDAR data representing the distances to the surface(s) and/or relative velocities of the surface(s) with respect to the LiDAR apparatus.

14. The method of claim 13, wherein the distances to the surface(s) are unconstrained, and the process includes calculating the different delays from respective measurements of the distances of the surface(s) from the LiDAR apparatus.

15. The method of claim 14, wherein each measurement of distance of the corresponding surface from the LiDAR apparatus is calculated by:
(i) receiving range-finding signal data representing a portion of a corresponding range-finding optical signal scattered and/or reflected by the corresponding surface and received by the corresponding optical receiver, the range-finding optical signal being modulated by a corresponding pseudo-random bit sequence;
(ii) processing the range-finding signal data to generate corresponding frequency compensated signal data representing a frequency compensated signal corresponding to the received signal, but in which the Doppler shifted angular frequency has been removed (if present in the signal) and the corresponding pseudo-random bit sequence is encoded into an amplitude of the frequency compensated signal; and
(iii) correlating the frequency compensated signal with a template of the corresponding pseudo-random bit sequence to generate the measurement of the distance of the corresponding surface from the LiDAR apparatus.

16. The method of claim 13, including controlling respective optical modulators to modulate the optical signals with the respective different delays.

17. The method of claim 13, wherein the processing includes demodulating the digital signal data using a correspondingly delayed digital signal template to generate a first demodulated output, and demodulating the first demodulated output using a phase locked loop to generate a second demodulated output, and using a cascaded integrator comb filter to decimate the second demodulated output by an integer multiple of a code length in samples.

18. At least one computer-readable storage medium storing processor-executable instructions that, when executed by at least one processor of a LiDAR apparatus, cause the at least one processor to execute the method of claim 13.

19. At least one non-volatile storage medium storing FPGA configuration data that, when used to configure an FPGA, causes the FPGA to execute the method of claim 13.

20. At least one non-volatile storage medium storing processor-executable instructions and FPGA configuration data that, when respectively executed by at least one processor of a LiDAR apparatus and used to configure an FPGA, causes the at least one processor and FPGA to execute the method of claim 13.
